(19) United States
(12) Patent Application Publication
(10) Pub. No.: US 2016/0053959 A1
(43) Pub. Date: Feb. 25, 2016

(54) SHIELDING APPARATUS FOR VEHICLE LAMP

(71) Applicant: Hyundai Motor Company, Seoul (KR)

(72) Inventors: Jae Hong KIM, Suwon-si (KR); Se Wook OH, Anyang-si (KR); Jeong Gyu YANG, Yongin-si (KR)

(73) Assignee: Hyundai Motor Company, Seoul (KR)

(21) Appl. No.: 14/562,446

(22) Filed: Dec. 5, 2014

(30) Foreign Application Priority Data
Aug. 20, 2014 (KR) 10-2014-0108359

(51) Int. Cl. F21S 8/10

(52) U.S. Cl. CPC F21S 48/1784; F21S 48/145

(57) ABSTRACT

Disclosed is a shielding apparatus for a vehicle lamp disposed on a moving path of light emitted from a reflector to control an irradiated quantity of light. The apparatus may include a plurality of shield panels configured to be adjacently disposed to each other, have ends coupled with a plurality of rotation shafts, and rotate in a parallel direction with a surface to control the irradiation quantity of light. The apparatus may also include a driver configured to be coupled with the plurality of shield panels to rotate the plurality of shield panels depending on an operation signal.

### CROSS REFERENCE TO RELATED APPLICATION

The present application claims priority of Korean Patent Application Number 10-2014-0108359 filed on Aug. 20, 2014, the entire contents of which application are incorporated herein for all purposes by this reference.

### BACKGROUND OF THE INVENTION

1. Technical Field

The present invention relates to a shielding apparatus for a vehicle lamp, and more particularly, to a shielding apparatus for a vehicle lamp capable of spreading a low beam and a high beam by interrupting or transmitting some of light irradiated in front of a reflector.

2. Description of the Related Art

Generally, a vehicle lamp is largely configured of a head lamp which helps a driver secure a field of view at the time of night driving of a vehicle by irradiating light in front of the vehicle and a tail lamp which helps a driver of a following vehicle recognize whether a brake pedal of a leading vehicle is pressed and helps a driver of a following vehicle recognize a position of a leading vehicle.

The head lamp is configured to irradiate a low beam forward within a regulation range in which a driver's field of view of an oncoming vehicle at the time of night driving of a vehicle as usual is not hindered but may also be configured to irradiate a high beam which helps a driver of a leading vehicle recognize risks or when a larger amount of light quantity is intermittently required.

The existing vehicle lamp includes a plurality of bulbs having different quantities of light to switch the low beam and the high beam, but has a problem in that inconvenience is caused due to the management of the plurality of bulbs and an increase in costs is caused due to the mounting of the plurality of bulbs.

Therefore, the related art entitled “Apparatus For Driving Shield Of Head Lamp” proposes a shield driver which is driven in response to a driving signal output from a controller and a rotating shield which rotates by a predetermined angle by a driving of the shield driver and forms at least one shield protrusion on a cylindrical circumferential surface. By interrupting or transmitting light irradiated upward by the above configuration, it is possible to implement a low beam or a high beam using one bulb.

However, the related art has a problem in that a considerable force is required to rotate the shields due to a mismatch of centers of gravity thereof when the shields rotate depending on sizes of the shields and even though the shields rotate, since vibrations occur due to a rotational inertia of the shields, noise occurs and a switching speed is reduced.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

The present invention is to provide a shielding apparatus for a vehicle lamp capable of minimizing a rotational inertia of a shield and quickly switching the shield.

According to various aspects of the present invention, there is provided a shielding apparatus for a vehicle lamp disposed on a moving path of light emitted from a reflector to control an irradiated quantity of light, including: a plurality of shield panels configured to be adjacently disposed to each other, have ends coupled with a plurality of rotation shafts, and rotate in a parallel direction with a surface to control the irradiation quantity of light; and a driver configured to be coupled with the plurality of shield panels to rotate the plurality of shield panels depending on an operation signal.

The plurality of the rotation shafts may be coupled with the reflector along a circumferential portion of the reflector at a set interval toward a front of the reflector.

A respective shield panel in the plurality of the shield panels may be provided with a fastening hole substantially perpendicular to a surface of the respective shield panel and a corresponding rotation shaft in the plurality of the rotation shafts may be inserted into the fastening hole.

A respective shield panel in the plurality of the shield panels may have one end coupled with a corresponding rotation shaft in the plurality of the rotation shafts and a tip of the one end of the respective shield panel may be coupled with the driver.

The driver may include a connection link configured to connect the plurality of the shield panels and an actuator configured to move the connection link to rotate the plurality of the shield panels. The connection link may be formed to have a curvature set along the circumferential portion of the reflector.

The tip of the one end of the respective shield panel may be provided with a slot at a set distance from the corresponding rotation shaft so that the connection link is inserted into the slot. The slot may be formed to form a preset angle to a moving direction of the connection link so as to rotate the respective shield panel by a predetermined amount at a time of the movement of the connection link.

The shielding apparatus for a vehicle lamp may further include: a controller configured to control the driver at a time of applying a low beam signal so as to make adjacent side portions of adjacent shield panels overlap or contact each other so that the plurality of the shield panels is in a light shielding state.

The shielding apparatus for a vehicle lamp may further include: a controller configured to control the driver at a time of applying a high beam signal to rotate the shield panels so as to open a front of the reflector so that the plurality of the shield panels is in a light transmitting state.

A respective shield panel in the plurality of the shield panels may be formed so that an inclined surface shape, through which light generated from a light source passes in a state in which the adjacent side portions of adjacent shield panels overlap each other, has a low beam pattern shape.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a low beam mode of an exemplary shielding apparatus for a vehicle lamp according to the present invention; and

FIG. 2 is a diagram illustrating a high beam mode of an exemplary shielding apparatus for a vehicle lamp according to the present invention.

### DESCRIPTION OF THE PREFERRED EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

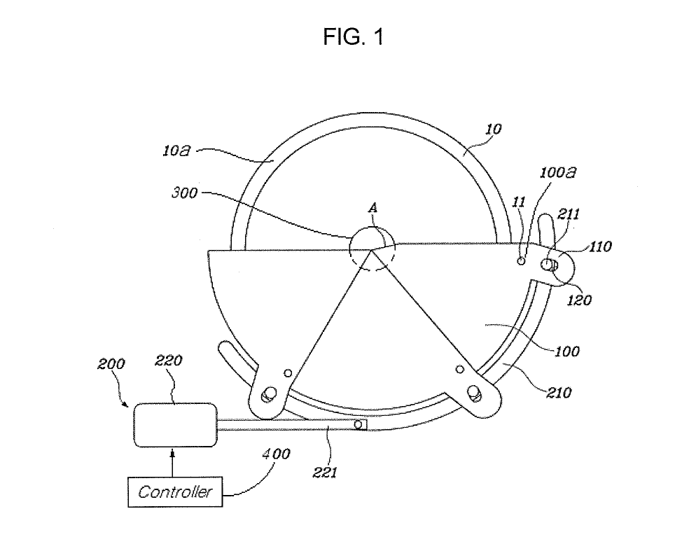

FIG. 1 is a configuration diagram illustrating a low beam mode of a shielding apparatus for a vehicle lamp according to various embodiments of the present invention, in which the shielding apparatus for a vehicle lamp which is disposed on a moving path of light emitted from a reflector 10 to control an irradiated quantity of light includes a plurality of shield panels 100 configured to be adjacently disposed to each other, have ends coupled with a rotation shaft, and rotate in a parallel direction with a surface 10a of the reflector 10 to control an irradiation amount of light; and a driver 200 configured to be coupled with the plurality of shield panels 100 to rotate the plurality of shield panels 100 depending on an operation signal.

The reflector 10 is configured of an upper reflecting surface and a lower reflecting surface and light reflected from a light source 300 through the upper reflecting surface enters a lower end of a lens which is located in front of the reflector 10 to form a low beam and light reflected through the lower reflecting surface enters an upper end of the lens to form a high beam. Therefore, as the light reflected from the lower reflecting surface is shielded or transmitted, the low beam and the high beam may be selectively irradiated, such that the high beam may be implemented without a separate light source 300 for the high beam.

Therefore, the shielding apparatus for a vehicle lamp according to various embodiments of the present invention shields the light reflected from the lower reflecting surface to prevent the light from being incident on the lens, thereby implementing the low beam and transmits the light reflected from the lower reflecting surface according to the operation signal of the high beam to be incident on the lens, thereby implementing the high beam.

Describing in more detail the shielding apparatus for a vehicle lamp according to various embodiments of the present invention with reference to FIG. 1, the shield panel 100 may be disposed in front of the reflector 10 from which light is emitted and may be disposed on a moving path of the light reflected from the lower reflecting surface of the reflector 10 to shield the light so as to prevent the light from being incident on the lens. On the other hand, the shield panel 100 may not be disposed on the moving path of the light reflected from the upper reflecting surface to transmit the light, thereby forming the low beam. To this end, a size, a shape, and the like of the shield panel 100 may be set by a plurality of experiments.

As described herein, the shield panel 100 may have a panel shape to rotate in a direction parallel with a panel surface. To this end, one end of the shield panel 100 may be vertically or perpendicularly provided with a fastening hole 100a to the panel surface and may freely rotate by inserting a rotation shaft into the fastening hole 100a.

The plurality of rotation shafts 11 may be coupled with the reflector 10 along a circumferential portion of the reflector 10 at a set interval toward the front of the reflector 10 and the fastening holes 100a may be shaft-supported along the circumferential portion of the reflector 10 by being coupled with the rotation shafts 11. Further, the rotation shafts 11 need not necessarily be formed along the circumferential portion of the reflector 10 and may be fixed by a separate support bracket and a disposition interval and a disposition shape thereof may also not be formed along the circumferential portion of the reflector 10. Here, various exemplary embodiments may be present.

Further, the rotation shaft 11 may be fixedly coupled with the reflector 10 or the separate support bracket by methods such as injection, bonding, fastening, or the like, but a coupling portion with the shield panel 100 side is fixed to the rotation shaft 11 and a coupling portion with the reflector 10 or the separate support bracket may also be rotatably coupled therewith. Similarly, various exemplary embodiments may be present.

Further, the rotation shaft 11 may be protrudedly coupled with the reflector 10 to be parallel with a front direction of the reflector 10 but may also form an angle which is set by the front direction of the reflector 10 and the experiment to sufficiently cover the light reflected from the lower reflecting surface. Similarly, various exemplary embodiments may be implemented.

A distance between the respective rotation shafts 11 may be variously set by the experiment depending on a rotating radius of the shield panel 100, a size of the shield panel 100, the number of shield panels 100, and the like.

Meanwhile, a tip of one end of the shield panel 100 may be coupled with the driver 200 and may be provided with a protrusion 110 which protrudes to couple the driver 200 with the protrusion 110. Further, the protrusion may not be formed.

As the driver 200 is adjacently coupled with the one end of the shield panel 100, the other end of the shield panel 100 rotates having a larger moving distance than the moving distance of the driver 200, such that a mechanism having a rapid and efficient layout may be implemented.

Further, the driver 200 may include a connection link 210 connecting between the plurality of shield panels 100 to rotate the plurality of shield panels 100 at a time and an actuator 220 which moves the connection link 210 to rotate the plurality of shield panels 100. Further, the connection link 210 is coupled with a plurality of pins 211 at a set interval and the tip of the one end of the shield panel 100 may be provided with slots 120 at a set distance from the rotation shaft 11 so that the pins 211 may be inserted into the slots 120. The pin 211 may be coupled by various methods such as fusion, injection, bonding, and fastening.

The pin 211 may be disposed to have a similar interval to an interval formed between the rotation shafts 11 and a set distance between the slot 120 and the rotation shaft 11 may be determined by an experiment in consideration of a rotating distance ratio between the connection link 210 and the other end of the shield panel 100 depending on a ratio of a distance from the rotation shaft 11 to the other end of the shield panel 100 to a distance from the rotation shaft 11 to the slot 120. As the set distance becomes short, the ratio of the rotating distance of the shield panel 100 to the moving distance of the connection link 210 is increased. Preferably, the distance from the rotation shaft 11 to the slot 120 may be set to satisfy the rotating distance by the operation of the actuator 220 based on the rotating distance of the shield panel 100 which is set to open the shield panel 100 to be suitable to implement the high beam. The rotating distance may be determined in consideration of the shape, size, and the like of the shield panel 100.

In this configuration, the actuator 220 is a solenoid, in which an operation shaft 221 inserted into the solenoid is provided to be drawn from an inside of the solenoid or received inside the solenoid according to a control signal, an end of the operation shaft 221 is hinge-coupled with the connection link 210, and the connection link 210 moves along with a horizontal or lateral movement of the operation shaft 221 to rotate the shield panel 100 based on the rotation shaft 11.

Further, a length of the slot 120 is associated with a rotation amount of the shield panel 100 and as the length of the slot 120 is increased, the connection link 210 may move more and thus the rotation of the shield panel 100 may be increased more, such that the length of the slot 120 may also be set depending on the rotation amount of the shield panel 100 set by the experiment.

The slot 120 is formed and thus the shield panel 100 may rotate along with the movement of the connection link 210 and both ends of the slot 120 serve as a stopper to limit the moving range of the connection link 210 and thus the shield panel 100 may rotate only by the set amount.

In some embodiments, the connection link 210 has a curvature similarly set to that of the circumferential portion of the reflector 10 along the circumferential portion of the reflector 10 or may be formed in a panel form, such that a uniform operation force may be applied to each pin 211 to apply a uniform rotation force to each shield panel 100. Further, the connection link 210 need not necessarily be formed as the curvature and therefore may be formed in various forms.

In some embodiments, the shielding apparatus for a vehicle lamp according to various embodiments of the present invention may further include the controller 400 which controls the driver 200 at the time of applying the low beam signal to make adjacent side portion overlap or contact each other between the respective shield panels 100.

In detail, the controller 400 controls the actuator 220 so that the operation shaft 221 of the actuator 220 is received to have the side portions opposite to each other maintained between the adjacent shield panels 100 among the plurality of shield panels 100 in the state in which the side portions overlap or contact each other at the time of applying the low beam signal or at a normal time when a lighting system is not operated, such that the shield panel 100 is in a light shielding state. If the actuator 220 receives the operation shaft 221 at the time of non-application of power and protrudes the operation shaft 221 at the time of application of power, the controller 400 does not apply power to the actuator 220 so that the shield panel 100 may be in a light shielding state.

Further, the shield panel 100 is formed so that a shape of an inclined surface A through which the light generated from the light source 300 passes in the state in which the adjacent side portions of the respective shield panel 100 overlap or contact each other has a low beam pattern shape, such that the low beam pattern shape may appear forward at the time of irradiating the low beam. In this case, the inclined surface A through which the light generated from the light source 300 passes may be an inclined surface of an upper end of the shield panel 100 toward the upper end of the reflector 10.

Meanwhile, the controller 400 may control the actuator 220 of the driver 200 at the time of applying the high beam signal to rotate the shield panels 100 so as to open the front of the reflector 10.

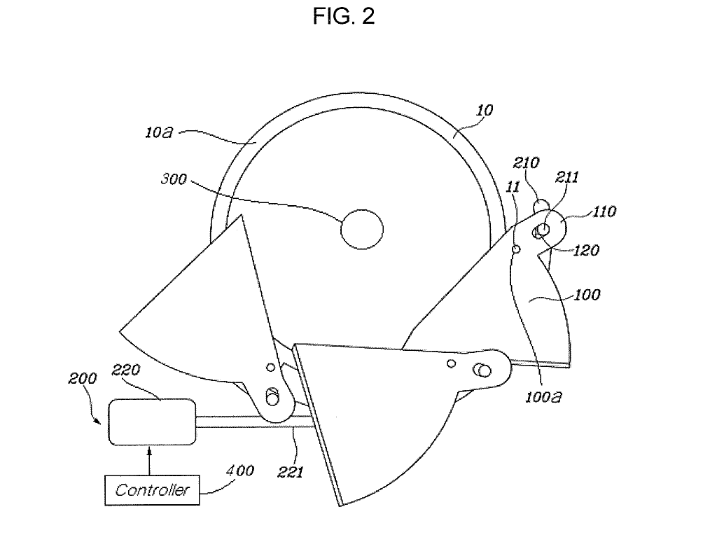

FIG. 2 illustrates an appearance in which the controller 400 rotates the shield panels 100 to open the front of the reflector 10 according to the high beam signal, in which the actuator 220 is operated at the time of applying the high beam signal to protrude the operation shaft 221 of the actuator 220, and thus the connection link 210 moves to rotate the plurality of shield panels 100 in the same direction at a time so that the plurality of shield panels 100 are in a light transmitting state. As the result, the reflector 10 is opened, and thus the light reflected from the lower reflecting surface may be irradiated forward.

Although exemplary embodiments of the present invention describes the case in which the shield panels 100 are in the light transmitting state when the operation shaft 221 of the actuator 220 protrudes, when the operation shaft 221 is received by changing the position of the actuator 220, the shield panels 100 are in the light transmitting state and when the operation shaft 221 protrudes, the shield panels 100 may also be set to be in the light shielding state.

According to the shielding apparatus for a vehicle lamp of the present invention, even though the size of the shield panel is increased, it is possible to quickly rotate the shield panel and it is possible to solve the problem of the occurrence of noise or vibration, the reduction in responsiveness, and the like due to the impact occurrence by minimizing the impact occurrence due to the inertia.

For convenience in explanation and accurate definition in the appended claims, the terms “upper” or “lower”, “front” or “rear”, “vertical” or “horizontal”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shielding apparatus for a vehicle lamp disposed on a moving path of light emitted from a reflector to control an irradiated quantity of light, the apparatus comprising:
a plurality of shield panels configured to be adjacently disposed to each other, have ends coupled with a plurality of rotation shafts, and rotate in a parallel direction with a surface of the reflector to control the irradiation quantity of light; and
a driver configured to be coupled with the plurality of shield panels to rotate the plurality of shield panels depending on an operation signal.

2. The shielding apparatus for a vehicle lamp of claim 1, wherein the plurality of the rotation shafts are coupled with the reflector along a circumferential portion of the reflector at a set interval toward a front of the reflector.

3. The shielding apparatus for a vehicle lamp of claim 2, wherein a respective shield panel in the plurality of the shield panels is provided with a fastening hole substantially perpendicular to a surface of the respective shield panel and a corresponding rotation shaft in the plurality of the rotation shafts is inserted into the fastening hole.

4. The shielding apparatus for a vehicle lamp of claim 1, wherein a respective shield panel in the plurality of the shield panels has one end coupled with a corresponding rotation shaft in the plurality of the rotation shafts and a tip of the one end of the respective shield panel is coupled with the driver.

5. The shielding apparatus for a vehicle lamp of claim 4, wherein the driver includes a connection link configured to connect the plurality of the shield panels and an actuator configured to move the connection link to rotate the plurality of the shield panels.

6. The shielding apparatus for a vehicle lamp of claim 5, wherein the connection link is formed to have a curvature set along the circumferential portion of the reflector.

7. The shielding apparatus for a vehicle lamp of claim 5, wherein the tip of the one end of the respective shield panel is provided with a slot at a set distance from the corresponding rotation shaft so that the connection link is inserted into the slot.

8. The shielding apparatus for a vehicle lamp of claim 1, further comprising:
a controller configured to control the driver at a time of applying a low beam signal so as to make adjacent side portions of adjacent shield panels overlap or contact each other so that the plurality of the shield panels is in a light shielding state.

9. The shielding apparatus for a vehicle lamp of claim 1, further comprising:
a controller configured to control the driver at a time of applying a high beam signal to rotate the shield panels so as to open a front of the reflector so that the plurality of the shield panels is in a light transmitting state.

10. The shielding apparatus for a vehicle lamp of claim 8, wherein a respective shield panel in the plurality of the shield panels is formed so that an inclined surface shape, through which light generated from a light source passes in a state in which the adjacent side portions of adjacent shield panels overlap each other, has a low beam pattern shape.
